(19) United States
(12) Patent Application Publication
(10) Pub. No.: US 2025/0278883 A1
(43) Pub. Date: Sep. 4, 2025

(54) SYSTEMS AND METHODS FOR NEAR DUPLICATE PHOTO FILTERING

(71) Applicant: GOOGLE LLC, Mountain View, CA (US)

(72) Inventors: Fitsum REDA, Mountain View, CA (US); Jane KONTKANEN, San Francisco, CA (US); Claire YAO, Dublin, CA (US); Andrew GALLAGHER, Fremont, CA (US); Ting LIU, Los Angeles, CA (US)

(21) Appl. No.: 18/862,474

(22) PCT Filed: May 24, 2022
(86) PCT No.: PCT/US2022/030630

§ 371 Date: Nov. 1, 2024

(51) Int. Cl. G06T 13/80; G06T 7/215; G06V 10/46; G06V 10/74

(52) U.S. Cl. CPC G06T 13/80; G06T 7/215; G06V 10/761; G06T 2207/30168; G06V 10/462

(57) ABSTRACT

Methods are provided for selecting pairs of images from which to generate simulated video sequences by interpolating between the pairs of images. A variety of filters are provided by assessing the quality of such image pairs, such that the quality of the simulated video generated by pairs of images selected thereby is improved. These filters can be performed sequentially, with subsequent filters only executed if all preceding filters have ‘passed,’ thereby reducing the computational cost. Some of the filters include generating, for a pair of images, respective embeddings of the images into a representational space and then comparing the embeddings. Some of the filters include generated a test interpolation image between the pair of images and then assessing a similarity between the test image and the pair of images. Some of the filters include determining optical flow between the pair of images.

### BACKGROUND

When a large collection of images is available (e.g., a set of images uploaded to a user's personal online photo album), it is possible that pairs of images within the collection may be very similar. It is possible to generate video sequences from such pairs (or more) of similar images, using machine learning models to interpolate a plurality of video frames between the pairs of images, thereby generating simulated video clips of the events depicted in the image pairs. Such simulated video sequences can be used to represent the contents of a photo album (e.g., to represent the album as a whole, to represent a locale or period of time represented within the album), to be presented interspersed with the photos of the album, or to be presented or used in some other way. Such video sequences could be provided in order to encourage review of and interaction with an image album, e.g., by providing such a video sequence as part of a “historical events” user interface element that presents videos and images taken on the present date in past years.

### SUMMARY

In a first aspect, a method is provided that includes: (i) obtaining a first image and a second image; (ii) determining that the first image and second image satisfy a first similarity criterion; (iii) responsive to determining that the first image and second image satisfy the first similarity criterion, determining that the first image and second image satisfy a second similarity criterion, wherein determining that the first image and second image satisfy the second similarity criterion has a higher computational cost than determining that the first image and second image satisfy the first similarity criterion; and (iv) responsive to determining that the first image and second image satisfy the second similarity criterion, generating a video sequence based on the first image and second image, wherein the video sequence comprises a plurality of interpolated images corresponding to respective different points in time between a first time associated with the first image and a second time associated with the second image.

In a second aspect, a method is provided that includes: (i) applying an interpolator to a first image and a second image to generate a test interpolated image between the first image and the second image; (ii) determining that the test interpolated image differs from the first image and the second image by less than a threshold amount; and (iii) responsive to determining that the test interpolated image differs from the first image and the second image by less than a threshold amount, generating a video sequence based on the first image and second image, wherein the video sequence comprises a plurality of interpolated images corresponding to respective different points in time between a first time associated with the first image and a second time associated with the second image.

In a third aspect, a non-transitory computer readable medium is provided having stored therein instructions executable by a computing device to cause the computing device to perform the method of the first or second aspects.

In a fourth aspect, a system is provided that includes: (i) a controller comprising one or more processors; and (ii) a non-transitory computer readable medium having stored therein instructions executable by the controller device to cause the one or more processors to perform the method of the first or second aspects.

The foregoing summary is illustrative only and is not intended to be in any way limiting. In addition to the illustrative aspects, embodiments, and features described above, further aspects, embodiments, and features will become apparent by reference to the figures and the following detailed description and the accompanying drawings.

### BRIEF DESCRIPTION OF THE FIGURES

FIG. 1 illustrates aspects of an example method for selecting pairs of images from which to render video sequences.

FIG. 2 illustrates aspects of an example method for selecting pairs of images from which to render video sequences.

FIGS. 3A, 3B, 3C, 3D, 3E, 3F, 3G, and 3H illustrate an example first input image, an example second input image, and aspects of optical flow mapping between the first and second input images.

FIG. 4 illustrates aspects of an example system.

FIG. 5 illustrates a flowchart of an example method.

FIG. 6 illustrates a flowchart of an example method.

### DETAILED DESCRIPTION

The following detailed description describes various features and functions of the disclosed systems and methods with reference to the accompanying figures. The illustrative system and method embodiments described herein are not meant to be limiting. It may be readily understood that certain aspects of the disclosed systems and methods can be arranged and combined in a wide variety of different configurations, all of which are contemplated herein.

### I. Overview

It is possible to generate video sequences from pairs of similar images by using machine learning models to interpolate a plurality of video frames between the pairs of images. Such interpolation can be used to generate simulated video clips of the events depicted in the image pairs. Such simulated video can be desirable in itself (e.g., as an animated representation of events for which no recorded video is available) and/or as a visually engaging representation of a photo album or other collection of images from which the pair(s) of images was taken. For example, such a simulated video could be used to represent an album as a whole, or to represent a locale or period of time represented within such an album. Additionally or alternatively, such simulated video could be presented interspersed with the other photos of the album, or presented or used in some other way. Such video sequences could be provided in order to encourage review of and interaction with an image album, e.g., by providing such a video sequence as part of a “historical events” user interface element that presents videos and images taken on the present date in past years.

In practice, identification of pairs of images from which to generate such simulated video can be difficult. Selection of insufficiently similar pairs of images can result in simulated videos generated therefrom that exhibit aesthetically unpleasant artifacts, e.g., detached or vanishing limbs, vanishing people or objects, or other video artifacts. Disclosed herein are a variety of filtering methods that improve the quality of such simulated videos by providing improved rejection of image pairs that are likely to lead to simulated videos that include artefacts or that are otherwise undesirable.

Different filtering methods may differ with respect to their ability to accurately reject poor-quality image pairs and with respect to their computational cost. For example, a first filter could include comparing timestamps for the pair of images and rejecting the pair if the timestamps differ by more than a threshold amount (e.g., by more than two seconds), as images taken farther apart in time are less likely to be visually similar enough to result in high-quality simulated video. Such a filter is very computationally inexpensive (a simple comparison of two time values), but may not reliably reject poor-quality image pairs (e.g., a user could easily take two photos in two very different directions within a two-second period). In a second example, a pair of images could be applied to a machine learning model (e.g., an artificial neural network (ANN)) to generate respective embeddings of the images in a high-dimensional space that is representative of the high-level contents of the images, and the pair of images could be rejected if a distance (e.g., an L1 distance, an L2 distance) between the embeddings is greater than a threshold. Such a filter is computationally more expensive, but can be much more effective at rejecting poor-quality image pairs.

Accordingly, a sequential conditional execution method for executing different filters is disclosed herein. In example implementations, less computationally expensive filter(s) are first computed for a potential pair of images (e.g., a determination of whether a difference between timestamps for the images is less than a threshold difference). If the pair does not ‘pass’ the first filter, then the pair is rejected and subsequent filters are not executed. However, if the pair does pass the less expensive filter(s), then a subsequent, more computationally expensive filter is executed (e.g., generating embeddings for the images and performing a comparison thereof). This conditional execution can be chained for a specified number of filters in a sequence, with execution terminating and the image pair being rejected if any filter ‘fails’ the image pair. However, if all filters ‘pass’ the image pair, a simulated video sequence can then be responsively generated for the image pair by, e.g., using an interpolator to generate a plurality of interpolated images corresponding to respective different points in time between a first time associated with a first image of the pair and a second time associated with a second image of the pair.

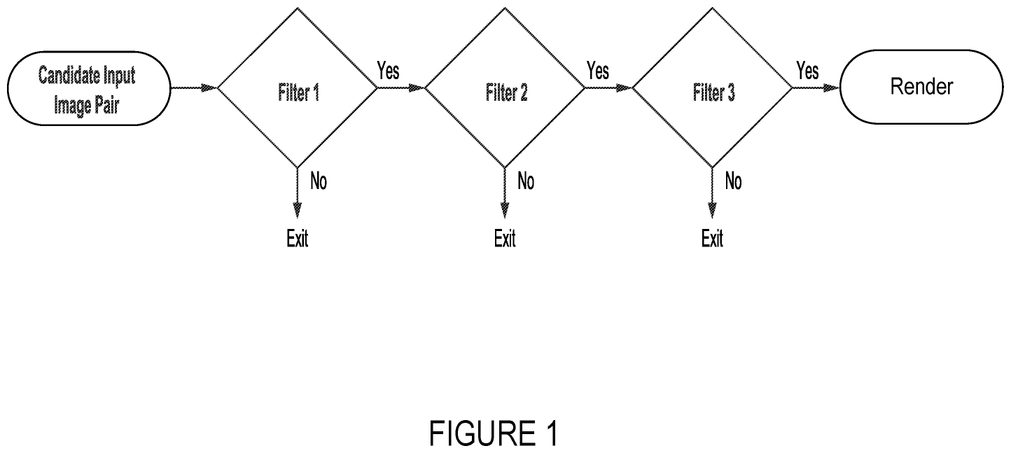

This is illustrated by way of example in FIG. 1, which depicts a conditionally-executed sequence of three filters “Filter 1,” “Filter 2,” and “Filter 3.” A candidate image pair (“Candidate Image Pair”) is presented to the first filter. If the image pair does not satisfy the requirements of the first filter (e.g., the timestamps of the images of the image pair differ by more than a threshold amount), the process terminates and the image pair is rejected. In addition, the process could be repeated by presenting one or more additional image pairs to the first filter (e.g., until a valid image pair is determined to satisfy all of the filters). If, instead, the candidate image pair does satisfy the requirements of the first filter, it is responsively applied to the second filter. Failure to satisfy the requirements of the second filter results in rejection of the candidate image pair, while satisfying the requirements of the second filter results in the candidate image pair being responsively presented to the third filter. Failure to satisfy the requirements of the third filter results in rejection of the candidate image pair, while satisfying the requirements of the third filter results in the candidate image pair being used to generate a simulated video sequence (“Render”), e.g., by applying a machine learning model or other interpolator to generate a plurality of different interpolated images corresponding to respective different points in time between the timings of the images of the candidate image pair. Thus, this conditional execution of filters results in reduced average computational cost to evaluate image pairs by avoiding execution of latter filters in the sequence if the pair fails with respect to an earlier filter.

Note that the “computational cost” of a particular filter, and thus its placement in an ordered sequence of conditionally-executed filters as described herein, could be dependent upon context. For example, an embedding vector could be determined for every image in a database upon acquisition of the images and stored for later use, e.g., to classify or organize the images, to determine information about the context or contents of the images, to provide a context-based image search, to facilitate identification of images that are semantically similar to a target image based on similarity of their embedding vectors, etc. In such an example, the “computational cost” of comparing the embeddings for a pair of images from such a database could be practically lessened, as the embeddings would not need to be re-computed (only accessed from the database). Accordingly, the “computational cost” of applying a filter that compares the embeddings for an image pair in that context could be less than the “computational cost” of applying a filter that includes generating an optical flow between the images, even if the computational cost of generating the optical flow de novo is less than the computational cost of generating the embeddings de novo.

A variety of filters, and combinations thereof, can be applied to determine whether to generate a simulated video sequence from a pair of images, e.g., as part of a sequence of conditionally-executed filters as described above. In some examples, two or more such filters could include the same computation. For example, two or more filters could be based on an optical flow determined between the two images of a pair, or two or more filters could be based on an interpolator generating a single test frame based on the images of the pair. In such examples, the results of such common computations could be stored when computed as part of an earlier filter and re-used for computation of the later filter, thus reducing the computational cost to assess a particular pair of images through such storage and re-use.

A variety of low-computational-cost filters (applied in a conditional sequence to an image pair, or applied in some other manner) based on image metadata could be applied to image pairs in order to determine whether to use the image pairs to generate a simulated video sequence. For example, a difference in timing between images in a pair of images could be compared to a threshold timing difference in order to determine whether the images were taken at approximately the same time. In another example, image metadata that is indicative of the quality of the images in a pair could be used. This could include determining whether the images have the same quality and/or determining that both images have quality values higher than a threshold quality value. In yet another example, information about the locations of generation of the images, the type of camera used to generate the images, the type or identity of a cellphone or other device used to generate the images, or some other metadata about the location or other circumstances of generation of the images in a pair could be used to determine whether the images are sufficiently similar to likely result in an acceptable simulated video sequence. In yet further examples, metadata describing the contents of the images of a pair could be compared (e.g., information about the composition of the images, the identity of people in the images, a type of location or event depicted by the images, a set of objects, animals, or people depicted in the images) and used to determine whether the images are sufficiently similar to likely result in an acceptable simulated video sequence.

In practice, image pairs often contain regions of particular visual interest and/or particular image contents that are either more likely to result in video artifacts and/or that are more likely to be noticed by a viewer as containing such artifacts. Hands, faces, and limbs are features that are often present in one image of a pair and not the other (e.g., due to motion of a person in the images) and/or that change sufficiently between the images of a pair to result in artifacts when such an image pair is used to generate a simulated video sequence. Accordingly, it can be advantageous to identify salient region(s) of the image(s) that contain such features and to modify one or more of the applied filters to increase the weight of discrepancies in such salient region(s) when determining whether an image pair is satisfactory. For example, where a filter includes determining a pixel-wise difference between the images of a pair, pixels within or near the identified salient region(s) could be weighted higher than other pixels when determining a weighted version of the pixel-wise difference between the images. In another example, the images could be cropped, lightened/darkened, tinted, or otherwise modified in order to emphasis the salient region(s) prior to applying a filter (e.g., prior to applying the images to an ANN to generate embedding vectors for the images).

Identification and location of such salient regions could be performed in a variety of ways. For example, an ANN or other machine learning model could be trained to determine the location, extent, type, or other information about one or more salient regions (e.g., regions containing human bodies, faces, limbs, hands, etc.) within the images of an image pair. Indeed, the outputs of such a salient region detector could, themselves, be applied as a filter to determine whether to use an image pair to generate a simulated video sequence. This could include, e.g., determining whether the identified salient region(s) in the images of the pair are sufficiently close together in the space of the images, whether the identified salient region(s) overlap by a sufficient amount or proportion, whether non-overlapping portions of the identified salient region(s) are sufficiently small, etc. Where multiple filters (e.g., of a conditionally-executed sequence of filters) use such identified salient region(s) within the images of an image pair, the location, extent, etc. determined for the identified salient region(s) could be determined once for the first filter use such information and then stored and re-used for any subsequently executed filters that use such information about salient regions.

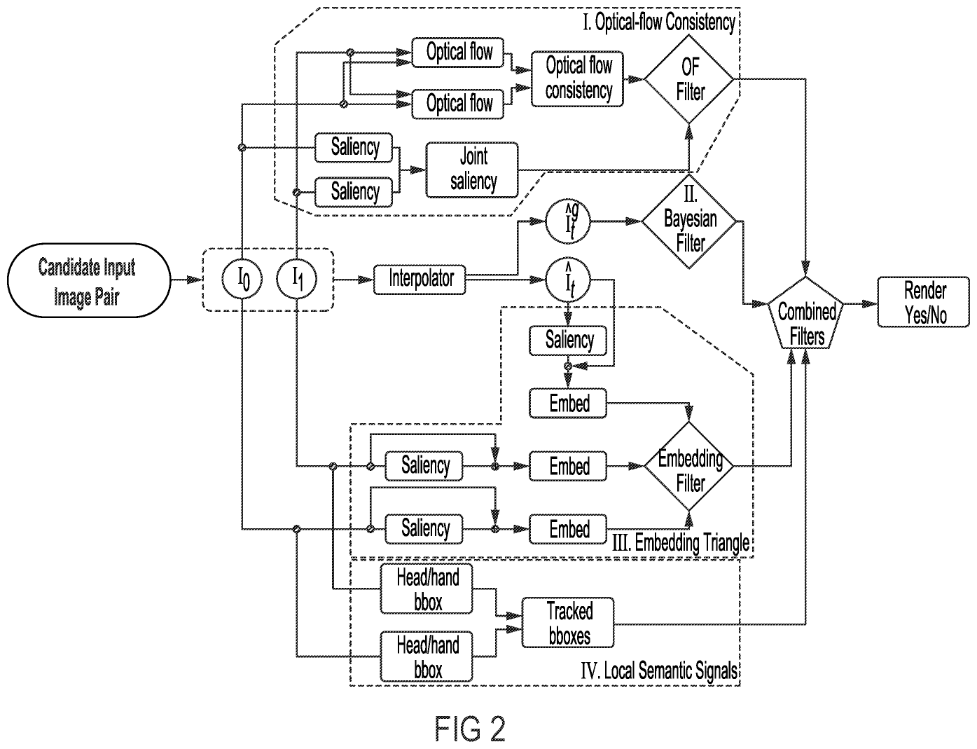

FIG. 2 depicts aspects of the computation of a variety of different filters for determining whether an input pair of images (I₀, I₁) are suitable for generating simulated video sequences therefrom. As depicted, four different filters are applied to the input images and combined (“Combined Filters”) to determine whether to generate, from the pair of images, a simulated video sequence (“Render Yes/No”). Such a combination could be summing the outputs of the filters or otherwise combining them to generate an overall filter output. E.g., determining whether a number of the four filters that ‘passed’ an image pair is greater than a threshold number of filters, or whether a weighted sum of the filter outputs exceeds a threshold value. Alternatively, the filters can be executed in a sequential, conditional manner (e.g., as described in connection with FIG. 1), in which case “combining” the filters takes the form of executing the filters according to the sequence, and terminating execution of the filters if the image pair “fails” with respect to any one of them (in which case subsequent filters in the sequence may not be executed, to save on computational cost).

Additionally, while the detection of salient region(s) within the images (“Saliency”) is depicted in a number of separate locations throughout FIG. 2, the operations of a saliency detector (e.g., the application of an ANN or other machine learning model to an image of the pair to determine the location, extent, content type, or other information about one or more regions of interest within the image) could be performed once, and the output of this operation stored, to allow for later re-use of the results of the saliency detection. For example, if the elements of the “Optical-flow Consistency” filter were executed first, then the outputs of the saliency detection process (e.g., location, extent, etc. of salient region(s)) performed on the first (“I₀”) and second (“I₁”) images of image pair under assessment could be stored. Later, when executing another filter (e.g., the “Embedding Triangle” filter), the stored outputs of the saliency detection process could be re-used.

A first filter depicted in FIG. 2 is a filter that determines consistency of optical flow in both directions between the images in the image pair (“Optical-flow consistency”). Two optical flow maps are determined (“Optical flow”) for the input images (one optical representing flow from the first image to the second, and the other representing optical flow from the second image to the first). The consistency of the optical flow maps is then determined (“Optical flow consistency”). This could be determined in a variety of ways. For example, each pixel (or other set of locations) in the first image could be shifted according to the first optical flow map (i.e., the optical flow map determined to represent optical flow from the first image to the second). These shifted pixels could be shifted again using the second optical flow map (i.e., the optical flow map determined to represent optical flow from the second image to the first), according to their shifted locations within the second optical flow map. A representation of the overall discrepancy between the initial and twice-shifted locations of the pixels could then be determined (“OF filter”) to represent the consistency between the first optical flow map and the second optical flow map (e.g., a root-mean-square sum of the discrepancies, a sum of absolute values of the discrepancies). More ‘consistent’ optical flow maps will result in less discrepancy (e.g., more pixels which, follow the two shifts, arrive at their original locations or very near thereto), and are more likely to represent image pairs that will result in higher-quality simulated video sequences.

As shown, a joint saliency (“Joint saliency”) is determined from the saliency region(s) determined from each of the input images of the pair and then used to weight the Optical-flow consistency filter's output (e.g., to emphasize the presence or absence of optical flow consistency in salient region(s) that contain hands, limbs, faces, etc.). This could include determining a union of the salient regions, a region of overlap (intersection) of the salient regions, or some other combination of the salient region(s) determined for each input image to represent a combined salient region(s) of the pair, which can be applied to weight the optical flow consistency analysis.

Some implementations could use optical flow in additional or alternative ways to provide filters for assessing image pairs. For example, one or both optical flow maps for an image pair could be used to determine an amount of one or both images that is occluded/disoccluded when transitioning from one of the images of the image pair to the other. Such metrics of occlusion/disocclusion (e.g., number or fraction of pixels occluded/disoccluded) can be effective as proxies for the amount of uncertainty in a putative interpolation between the images of the pair, as regions occluded/disoccluded must be generated by the interpolator based on context within the image. Such occlusion/disocclusion metrics could be weighted used one or more salient region(s) identified within the images of the pair such that occlusion/disocclusion proximate to hands, limbs, faces, etc. is emphasized when evaluating the filter.

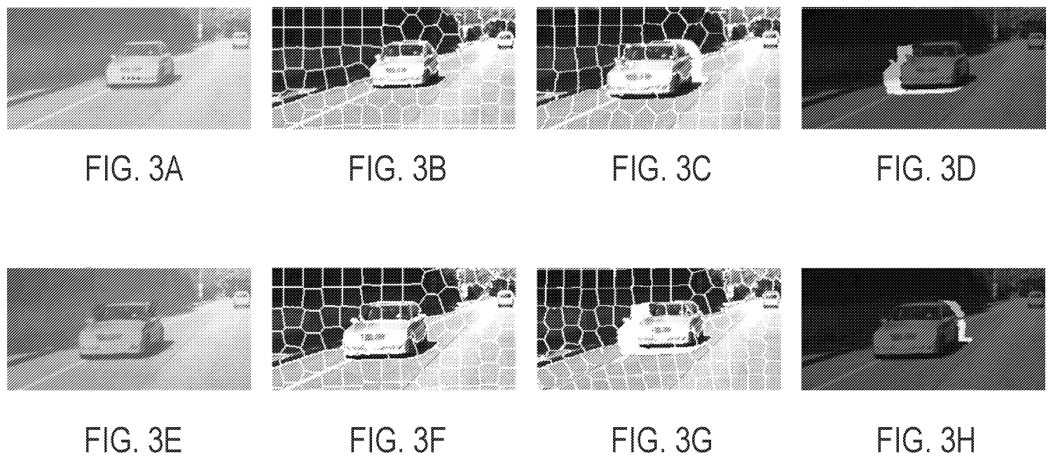

FIGS. 3A-3H illustrate aspects of such an occlusion/disocclusion-based filter process. FIGS. 3A and 3E depict first and second images of an image pair being assessed. A superpixel-based optical flow technique (used here as an illustrative, no-limiting example of an optical flow technique) was applied to the images to generate a forward optical flow map (from the first image to the second image, aspects of which are depicted in FIG. 3B-3D) and a reverse optical flow map (from the second image to the first image, aspects of which are depicted in FIG. 3F-3G). FIGS. 3B and 3F depict the superpixels determined for the first and second images, respectively as part of the forward and reverse optical flow maps, respectively. FIGS. 3C and 3G depict the distortion of the first and second images, respectively, according to the first and second optical flow maps, respectively, to approximate the second and first images, respectively. These transformations result in portions of the first and second images being disoccluded (white regions of FIGS. 3C and 3G). Conversely, these result in portions of the first and second images being occluded (lightened regions of FIGS. 3D and 3H, which depict the first and second images, respectively).

Some or all of these occlusions/disocclusions could be used, optionally weighted according to one or more identified salient regions within the images, to determine whether the first and second images should be used to generate a simulated video sequence. This could include comparing one or both of the disocclusions to a disocclusion threshold (e.g., a threshold fraction of the image(s) disoccluded) and/or comparing one or both of the occlusions to an occlusion threshold (e.g., a threshold fraction of the image(s) occluded). In some examples, only one direction of optical flow map could be generated an analyzed, e.g., to reduce the computational cost to execute such an optical flow-based filter.

Some filters as described herein could be based on the generation of a “test” interpolated image by applying the images being applied to an interpolator (“Interpolator”). Such a test interpolated image can then be compared to the images of the image pair (e.g., using the filters depicted in FIG. 2 and/or additional filters as described herein) in order to determine whether to generate a full simulated video sequence from the image pair (e.g., by applying the same interpolator a plurality of additional times to generate additional interpolated images for respective different points in time between the images of the image pair). For interpolators that also provide an output indicative of the confidence of the interpolation, such a confidence output could, itself, be used to filter the image pair. For example, such a confidence output could be applied to a Bayesian filter (“Bayesian filter”) or other process (e.g., comparison to a threshold confidence value) in order to determine whether the image pair should be used to generate a simulated video sequence. The generated test interpolated image could be determined for a timepoint midway between the timepoints of the images of the image pair and/or for alternative or additional timepoints (e.g., multiple test interpolated images could be generated and used to assess the fitness of the image pair under assessment).

The test interpolated image can then be compared to the images of the image pair under test. As shown by way of example in FIG. 2, the test interpolated image and the images of the image pair are applied to an ANN or other machine learning model (“Embed”) to generate respective multidimensional embeddings that represent contents of the images of the image pair and of the test interpolated image. A variety of relevant models could be applied to obtain such embeddings. As shown in FIG. 2, this can optionally be done after applying information about identified salient region(s) in the image pair and/or to the test interpolated image (e.g., to brighten/darken the images, crop the images, or otherwise modify the images such that the generated embedding preferentially represent the contents of the salient region(s)). Salient region(s) could be determined independently for the test interpolated image, or such information could be determined based on saliency information for the images of the image pair (e.g., an overlap between salient region(s) determined for the image pair).

The embeddings are then compared (“Embedding filter”) in order to determine whether the image pair is likely to result in a satisfactory simulated video sequence (e.g., whether the test interpolated image is sufficiently similar to one or both of the images of the image pair). This could include determining a distance (e.g., an L1 distance, and L2 distance) between the embedding vector of the test interpolated image and an average of the embedding vectors for the images of the image pair. Such a distance could be determined as

$${\vert S ( {I}_{T} ) - S ( {I}_{0} ) + S ( {I}_{1} ) / 2 \vert}_{N} ,$$

where I_{T} is the test interpolated image frame, S() represents determining the embedding for an input image, and N is an integer equal to 1 or 2, to determine the L1 or L2 distances, respectively. Saliency information could be added by weighting the images according to a saliency map as

$${\vert S ( γ ( {I}_{T} ) {I}_{T} ) - S ( γ ( {I}_{o} ) {I}_{0} ) + S ( γ ( {I}_{1} ) {I}_{1} ) / 2 \vert}_{N} ,$$

where y() represents determining a saliency map for an input image (e.g., a map that is 1 for the salient region(s) and 0 for other regions, a map that smoothly transitions from higher value(s) within the salient region to lower value(s) outside the salient region, etc.).

Additionally or alternatively, such a triangle embedding filter could apply the embeddings to another ANN or other machine learning model that has been trained to identify “acceptable” triplets of test interpolated images and input image pairs, e.g., based on manually-labeled training data triplets.

Note that such “triangle” comparisons between a test interpolated image and parent image pairs could be performed outside of the context of multidimensional image embeddings. For example, a pixelwise comparison could be determined between the test interpolated image and an average of the images of the image pair. This could be determined as

$${\vert {I}_{T} - {I}_{0} + {I}_{1} / 2 \vert}_{N} ,$$

where I_{T} is the test interpolated image frame and N is an integer equal to 1 or 2, to determine the L1 or L2 distances between pixels of the test interpolated image and the average of the pixels of the image pair, respectively. Such differences could be determined across the pixels with respect to luminance, chrominance, individual color channels, or some combination (e.g., a sum, for each pixel, of the differences determined for each color channel). As noted elsewhere herein, such a pixelwise comparison could be weighted according to determined salient region(s) within the test interpolated image and/or the images of the image pair, e.g., as

$${\vert γ ( {I}_{T} ) {I}_{T} - γ ( {I}_{o} ) {I}_{0} + γ ( {I}_{1} ) {I}_{1} / 2 \vert}_{N} .$$

Yet further, note that embeddings and/or pixelwise differences for the images of the image pair could be compared directly as an additional or alternative filter. Such a filter could be significantly less computationally costly than the triangle embedding filter described above, especially in circumstances where the embedding vectors for the images of the image pair have already been precomputed and stored for later use. Comparing the embedding vectors could include determining an L1 or L2 distance between the vectors and then comparing that distance to a threshold distance (optionally applying a saliency map to the images of the input pair prior to generating the embeddings). Performing a pixelwise comparison between the images of the image pair could include determining a pixelwise L1 or L2 distance between the images of the image pair (optionally weighting such a distance according to a saliency map as described above).

It is also possible to compare bounding boxes or other local semantic signals (“Head/hand bbox”) determined for heads, hands, limbs, or other contents of interest in the images of the image pair. Such bounding boxes, determine content locations, determined head poses, determined hand or limb poses, or other determined local semantic signals can then be tracked or otherwise compared between the images of the image pair (“Tracked bboxes”) in order to determine whether to use an image pair under test to generate a simulated video sequence. For example, the pose or location of a head, hand, or limb in a first image of the image pair could be compared to the location of a head, hand, or limb in a second image of the image pair and, if the pose or location differs by more than a threshold amount and/or if the head, hand, or limb cannot be located in the second image, the image pair could be rejected. In another example, if a salient region detected in the first image does not overlap with a salient region of the second image by at least a threshold amount, then the image pair could be rejected. The process used to determine salient region(s) within the images of the image pair could be the same as and/or have processes in common with the method used to determine bounding boxes or other local semantic signals for heads, hands, limbs, or other contents of interest in the images of the image pair.

Additional filters are possible to assess the fitness of image pairs to generate simulated video sequences. For example, mutual information or other statistical or information-theoretic metrics could be determined for image pairs and used (e.g., compared to relevant threshold values) to determine whether an image pair is suitable for generation of a simulated video sequence. This could include determining a two-dimensional histogram of counts representing how many times each intensity correspondence occurred for pixels of the images of the image pair. So, for example, if pixel [i,j] of the first image has an intensity of 4, and pixel [i,j] of the second image has an intensity of 6, then element [4,6] of the intensity histogram is incremented. In another example, if pixel [u,v] of the first image has an intensity of 9, and pixel [u,v] of the second image has an intensity of 6, then element [9,6] of the intensity histogram is incremented. The mutual information of the image pair can then be determined from such a histogram in a variety of ways. For example, as the Kullback-Leibler distance,

$$I ( A , B ) = {Σ}_{a , b} p ( a , b ) log \frac{p ( a , b )}{p ( a ) p ( b )} ,$$

where p(a,b) is the probability of observing a pixel of the first image at an intensity of a and the corresponding pixel of the second image at an intensity of b, p(a) is the probability of observing a pixel of the first image at an intensity of a, and p(b) is the probability of observing a pixel of the first image at an intensity of b.

In some examples, a filter can include an ANN or other machine learning model trained to determine, based on an input image pair and/or input multidimensional embeddings for an input image pair, an output value that can then be compared to a threshold value or otherwise used to determine whether the image pair is fit to be used to generate a simulated video sequence. This could include training the machine learning model on a training set of image pairs and labels indicating whether the image pair is fit (e.g., by applying an interpolator to generate the simulated video sequence and then receiving manual input indicative of whether the video sequence is acceptable). Additionally or alternatively, such a machine learning model could be trained to generate an expensive-to-compute output (e.g., mutual information) and that output could then be used to assess the image pair (e.g., by comparison to a threshold mutual information value).

When conditionally executed in a sequence to evaluate an image pair, less computationally expensive filters can be placed earlier in the sequence than more computationally expensive filters. This can have the effect of reducing the computational cost to evaluate a set of candidate image pairs by avoiding execution of later filters for image pairs that fail with respect to earlier filters in the sequence. This can include applying computationally inexpensive metadata-based filters (e.g., determining the timing of images of the image pair differs by less than a threshold time difference, determining that photo quality scores of the images of the image pair differ by less than a threshold amount, or determining content types of the image of the image pair differ by less than a threshold amount) prior to applying more computationally expensive filters (e.g., filters whose application includes determining an optical flow pattern, generating an embedding for an image, generating a test interpolation image, executing a machine learning model, determining a mutual information, determining a pixelwise difference between images). In some examples, this can include determining multidimensional embeddings for the image pair and/or determining optical flow map(s) between the images of the image pair prior to determining a mutual information for the image pair and/or generating a test interpolation image between the images of the image pair.

### II. Example Systems

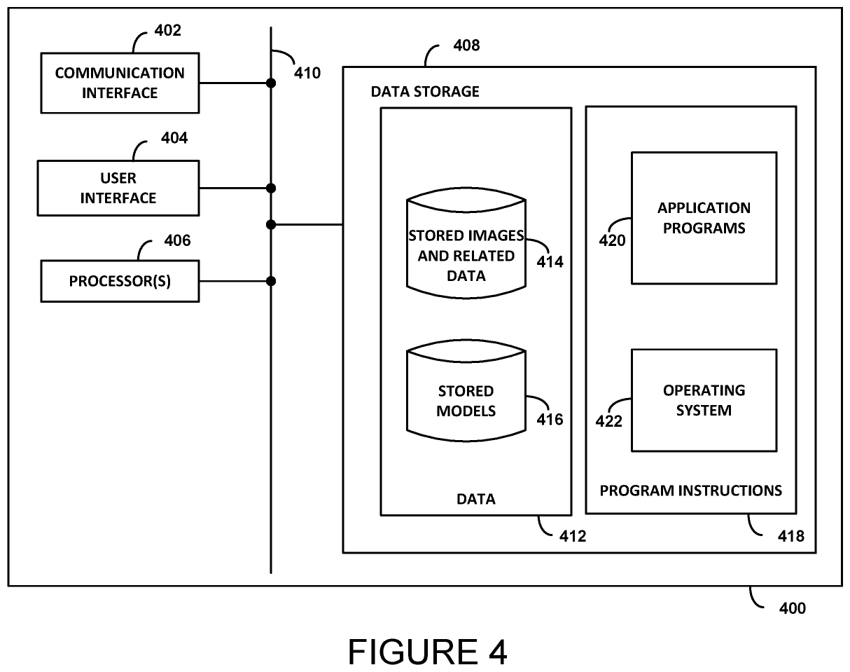

FIG. 4 illustrates an example system 400 that may be used to implement the methods described herein. By way of example and without limitation, system 400 may be or include a computer (such as a desktop, notebook, tablet, or handheld computer, a server), elements of a cloud computing system, or some other type of device or system. It should be understood that elements of system 400 may represent a physical instrument and/or computing device such as a server, a particular physical hardware platform on which applications operate in software, or other combinations of hardware and software that are configured to carry out functions as described herein.

As shown in FIG. 4, system 400 may include a communication interface 402, a user interface 404, one or more processor(s) 406, and data storage 408, all of which may be communicatively linked together by a system bus, network, or other connection mechanism 410.

Communication interface 402 may function to allow system 400 to communicate, using analog or digital modulation of electric, magnetic, electromagnetic, optical, or other signals, with other devices (e.g., with databases that contain sets of images or other image-related data, with cellphones or other sources of additional images), access networks, and/or transport networks. Thus, communication interface 402 may facilitate circuit-switched and/or packet-switched communication, such as plain old telephone service (POTS) communication and/or Internet protocol (IP) or other packetized communication. For instance, communication interface 402 may include a chipset and antenna arranged for wireless communication with a radio access network or an access point. Also, communication interface 402 may take the form of or include a wireline interface, such as an Ethernet, Universal Serial Bus (USB), or High-Definition Multimedia Interface (HDMI) port. Communication interface 402 may also take the form of or include a wireless interface, such as a Wifi, BLUETOOTH®, global positioning system (GPS), or wide-area wireless interface (e.g., WiMAX, 3GPP Long-Term Evolution (LTE), or 3GPP 5G). However, other forms of physical layer interfaces and other types of standard or proprietary communication protocols may be used over communication interface 402. Furthermore, communication interface 402 may comprise multiple physical communication interfaces (e.g., a Wifi interface, a BLUETOOTH® interface, and a wide-area wireless interface).

In some embodiments, communication interface 402 may function to allow system 400 to communicate, with other devices, remote servers, access networks, and/or transport networks. For example, the communication interface 402 may function to communicate with one or more servers (e.g., servers of a cloud computer system that provide computational resources for a fee) to provide images and to receive, in response, computed embeddings of the images, statistical analyses of the images (e.g., mutual information statistics), interpolations of the images, or other information related thereto. In another example, the communication interface 402 may function to communicate with one or more cellphones, tablets, or other computing devices to images and related data (e.g., timing data, metadata) therefrom.

User interface 404 may function to allow system 400 to interact with a user, for example to receive input from and/or to provide output to the user. Thus, user interface 404 may include input components such as a keypad, keyboard, touch-sensitive or presence-sensitive panel, computer mouse, trackball, joystick, microphone, and so on. User interface 404 may also include one or more output components such as a display screen which, for example, may be combined with a presence-sensitive panel. The display screen may be based on CRT, LCD, and/or LED technologies, or other technologies now known or later developed. User interface 404 may also be configured to generate audible output(s), via a speaker, speaker jack, audio output port, audio output device, earphones, and/or other similar devices.

Processor(s) 406 may comprise one or more general purpose processors—e.g., microprocessors—and/or one or more special purpose processors—e.g., digital signal processors (DSPs), graphics processing units (GPUs), floating point units (FPUs), network processors, tensor processing units (TPUs), or application-specific integrated circuits (ASICs). In some instances, special purpose processors may be capable of image processing, executing machine learning models, determining optical flow patterns, or other functions as described herein, among other applications or functions. Data storage 408 may include one or more volatile and/or non-volatile storage components, such as magnetic, optical, flash, or organic storage, and may be integrated in whole or in part with processor(s) 406. Data storage 408 may include removable and/or non-removable components.

Processor(s) 406 may be capable of executing program instructions 418 (e.g., compiled or non-compiled program logic and/or machine code) stored in data storage 408 to carry out the various functions described herein. Therefore, data storage 408 may include a non-transitory computer-readable medium, having stored thereon program instructions that, upon execution by system 400, cause system 400 to carry out any of the methods, processes, or functions disclosed in this specification and/or the accompanying drawings. The execution of program instructions 418 by processor(s) 406 may result in processor 406 using data 412.

By way of example, program instructions 418 may include an operating system 422 (e.g., an operating system kernel, device driver(s), and/or other modules) and one or more application programs 420 (e.g., functions for executing the methods described herein) installed on system 400. Data 412 may include stored images and related data 414 (e.g., image labels, timing data, metadata). Data 412 may also include stored models 416 (e.g., stored model parameters and other model-defining information) that can be executed as part of the methods described herein (e.g., to determine an embedding for an input image, to generate a filter output based on two or more input embeddings).

Application programs 420 may communicate with operating system 422 through one or more application programming interfaces (APIs). These APIs may facilitate, for instance, application programs 420 transmitting or receiving information via communication interface 402, receiving and/or displaying information on user interface 404, and so on.

Application programs 420 may take the form of “apps” that could be downloadable to system 400 through one or more online application stores or application markets (via, e.g., the communication interface 402). However, application programs can also be installed on system 400 in other ways, such as via a web browser or through a physical interface (e.g., a USB port) of the system 400.

### III. Example Methods

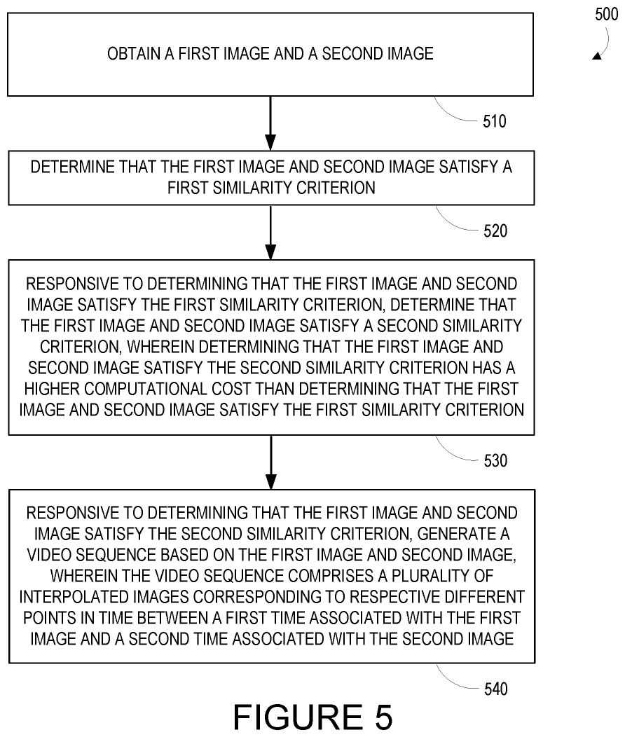

FIG. 5 depicts an example method 500. The method 500 includes obtaining a first image and a second image (510). The method 500 additionally includes determining that the first image and second image satisfy a first similarity criterion (520). The method 500 also includes, responsive to determining that the first image and second image satisfy the first similarity criterion, determining that the first image and second image satisfy a second similarity criterion, wherein determining that the first image and second image satisfy the second similarity criterion has a higher computational cost than determining that the first image and second image satisfy the first similarity criterion (530). The method yet further includes, responsive to determining that the first image and second image satisfy the second similarity criterion, generating a video sequence based on the first image and second image, wherein the video sequence comprises a plurality of interpolated images corresponding to respective different points in time between a first time associated with the first image and a second time associated with the second image (540). The method 500 could include additional steps or features.

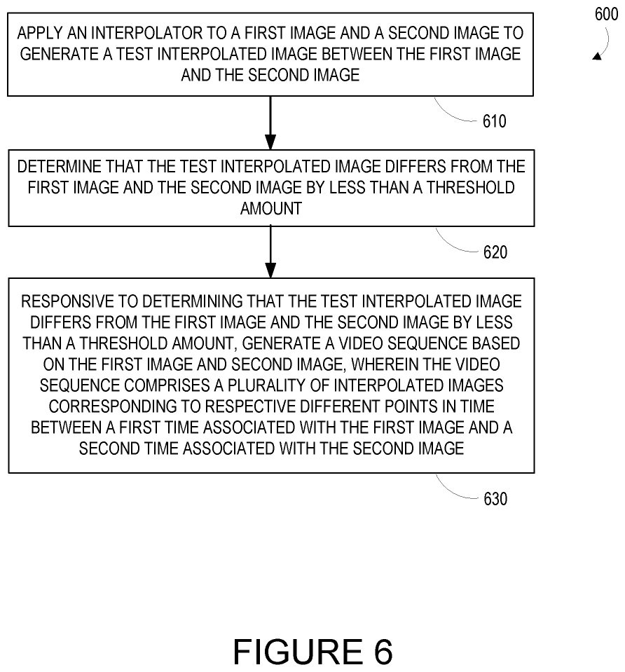

FIG. 6 depicts an example method 600. The method 600 includes applying an interpolator to a first image and a second image to generate a test interpolated image between the first image and the second image (610). The method 600 additionally includes determining that the test interpolated image differs from the first image and the second image by less than a threshold amount (620). The method 600 also includes, responsive to determining that the test interpolated image differs from the first image and the second image by less than a threshold amount, generate a video sequence based on the first image and second image, wherein the video sequence comprises a plurality of interpolated images corresponding to respective different points in time between a first time associated with the first image and a second time associated with the second image (630). The method 600 could include additional steps or features.

It should be understood that arrangements described herein are for purposes of example only. As such, those skilled in the art will appreciate that other arrangements and other elements (e.g. machines, interfaces, operations, orders, and groupings of operations, etc.) can be used instead of or in addition to the illustrated elements or arrangements.

### IV. Conclusion

It should be understood that arrangements described herein are for purposes of example only. As such, those skilled in the art will appreciate that other arrangements and other elements (e.g. machines, interfaces, operations, orders, and groupings of operations, etc.) can be used instead, and some elements may be omitted altogether according to the desired results. Further, many of the elements that are described are functional entities that may be implemented as discrete or distributed components or in conjunction with other components, in any suitable combination and location, or other structural elements described as independent structures may be combined.

While various aspects and implementations have been disclosed herein, other aspects and implementations will be apparent to those skilled in the art. The various aspects and implementations disclosed herein are for purposes of illustration and are not intended to be limiting, with the true scope being indicated by the following claims, along with the full scope of equivalents to which such claims are entitled. It is also to be understood that the terminology used herein is for the purpose of describing particular implementations only, and is not intended to be limiting.

1. A method comprising:
obtaining a first image and a second image;
determining that the first image and second image satisfy a first similarity criterion;
responsive to determining that the first image and second image satisfy the first similarity criterion, determining that the first image and second image satisfy a second similarity criterion, wherein determining that the first image and second image satisfy the second similarity criterion has a higher computational cost than determining that the first image and second image satisfy the first similarity criterion; and
responsive to determining that the first image and second image satisfy the second similarity criterion, generating a video sequence based on the first image and second image, wherein the video sequence comprises a plurality of interpolated images corresponding to respective different points in time between a first time associated with the first image and a second time associated with the second image.

2. The method of claim 1, wherein generating the video sequence responsive to determining that the first image and second image satisfy the second similarity criterion comprises:
responsive to determining that the first image and second image satisfy the second similarity criterion, determining that the first image and second image satisfy a third similarity criterion, wherein determining that the first image and second image satisfy the third similarity criterion has a higher computational cost than determining that the first image and second image satisfy the second similarity criterion; and
responsive to determining that the first image and second image satisfy the third similarity criterion, generating the video sequence.

3. The method of claim 1, wherein determining that the first image and second image satisfy a first similarity criterion comprises at least one of:
determining that the first time associated with the first image and the second time associated with the second image differ by less than a threshold time difference,
determining that a photo quality score of the first image and a photo quality score of the second image differ by less than a threshold amount, or
determining that a content type of the first image and a content type of the second image differ by less than a threshold amount.

4. The method of claim 1, wherein at least one of determining that the first image and second image satisfy the first similarity criterion or determining that the first image and second image satisfy the second similarity criterion comprises:
determining that a first multidimensional embedding that represents contents of the first image differs from a second multidimensional embedding that represents contents of the second image by less than a threshold amount.

5. (canceled)

6. The method of claim 4, further comprising:
determining a first location of a first salient region within the first image; and
determining the first multidimensional embedding based on the first image in a manner that preferentially weights contents of the first salient region within the first image.

7. (canceled)

8. The method of claim 1, wherein at least one of determining that the first image and second image satisfy the first similarity criterion or determining that the first image and second image satisfy the second similarity criterion comprises:
determining that a pixelwise distance between the first image and the second image is less than a threshold distance.

9. The method of claim 8, wherein determining that a pixelwise distance between the first image and the second image is less than a threshold distance comprises:
determining a first location of a first salient region within the first image; and
determining the pixelwise distance between the first image and the second image in a manner that preferentially weights contents of the first salient region within the first image.

10. The method of claim 1, wherein at least one of determining that the first image and second image satisfy the first similarity criterion or determining that the first image and second image satisfy the second similarity criterion comprises:
applying an interpolator to the first image and the second image to generate a test interpolated image between the first image and the second image; and
determining that the test interpolated image differs from the first image and the second image by less than a threshold amount.

11. The method of claim 10, further comprising:
determining a first multidimensional embedding that represents contents of the test interpolated image, wherein determining that the test interpolated image differs from the first image and the second image by less than a threshold amount comprises determining that an average of a second multidimensional embedding that represents contents of the first image and a third multidimensional embedding that represents contents of the second image differs from the first multidimensional embedding by less than a threshold amount.

12. (canceled)

13. The method of claim 10, wherein determining that the test interpolated image differs from the first image and the second image by less than a threshold amount comprises
determining that a pixelwise distance between the test interpolated image and a pixelwise average of the first image and the second image is less than a threshold distance.

14. The method of claim 13, further comprising:
determining a first location of a first salient region within the first image, wherein determining that the test interpolated image differs from the first image and the second image by less than a threshold amount comprises determining that the test interpolated image differs from the first image and the second image by less than a threshold amount in a manner that preferentially weights contents of the first salient region within the first image.

15. The method of claim 10, wherein applying the interpolator to the first image and the second image to generate the test interpolated image between the first image and the second image includes generating a confidence output from the interpolator, and wherein determining that the test interpolated image differs from the first image and the second image by less than a threshold amount comprises determining that the confidence output exceeds a confidence threshold.

16. (canceled)

17. The method of claim 1, wherein at least one of determining that the first image and second image satisfy the first similarity criterion or determining that the first image and second image satisfy the second similarity criterion comprises:
determining a first optical flow pattern from the first image to the second image; and
determining a second optical flow pattern from the second image to the first image.

18. The method of claim 17, wherein at least one of determining that the first image and second image satisfy the first similarity criterion or determining that the first image and second image satisfy the second similarity criterion comprises:
determining that an optical flow consistency between the first optical flow pattern and the second optical flow pattern exceeds a threshold value.

19. The method of claim 18, further comprising:
determining a first location of a first salient region within the first image, wherein determining that the optical flow consistency between the first optical flow pattern and the second optical flow pattern exceeds a threshold value comprises determining that the optical flow consistency between the first optical flow pattern and the second optical flow pattern exceeds a threshold value in a manner that preferentially weights contents of the first salient region within the first image.

20. The method of claim 17, wherein at least one of determining that the first image and second image satisfy the first similarity criterion or determining that the first image and second image satisfy the second similarity criterion comprises:
determining, based on the first optical flow pattern, at least one of:
that a proportion of the first image that is disoccluded to form the second image via the first optical flow pattern exceeds a threshold disocclusion amount, or
that a proportion of the first image that is occluded to form the second image via the first optical flow pattern exceeds a threshold occlusion amount.

21. The method of claim 20, further comprising:
determining a first location of a first salient region within the first image, wherein at least one of:
determining that the proportion of the first image that is disoccluded to form the second image via the first optical flow pattern exceeds a threshold disocclusion amount comprises determining that the proportion of the first image that is disoccluded to form the second image via the first optical flow pattern exceeds a threshold disocclusion amount in a manner that preferentially weights contents of the first salient region within the first image, or
determining that the proportion of the first image that is occluded to form the second image via the first optical flow pattern exceeds a threshold occlusion amount comprises determining that the proportion of the first image that is occluded to form the second image via the first optical flow pattern exceeds a threshold occlusion amount in a manner that preferentially weights contents of the first salient region within the first image.

22. The method of claim 1, wherein at least one of determining that the first image and second image satisfy the first similarity criterion or determining that the first image and second image satisfy the second similarity criterion comprises:
determining a mutual information between the first image and the second image.

23. The method of claim 1, wherein determining that the first image and second image satisfy the first similarity criterion comprises at least one of:
determining that a first multidimensional embedding that represents contents of the first image differs from a second multidimensional embedding that represents contents of the second image by less than a threshold amount, or
determining a first optical flow pattern from the first image to the second image and determining a second optical flow pattern from the second image to the first image; and
wherein determining that the first image and second image satisfy the second similarity criterion comprises at least one of:
determining a mutual information between the first image and the second image, or
applying an interpolator to the first image and the second image to generate a test interpolated image between the first image and the second image and determining that the test interpolated image differs from the first image and the second image by less than a threshold amount.

24-29. (canceled)

30. A non-transitory computer readable medium having stored therein instructions executable by a computing device to cause the computing device to perform a method comprising:
obtaining a first image and a second image;
determining that the first image and second image satisfy a first similarity criterion;
responsive to determining that the first image and second image satisfy the first similarity criterion, determining that the first image and second image satisfy a second similarity criterion, wherein determining that the first image and second image satisfy the second similarity criterion has a higher computational cost than determining that the first image and second image satisfy the first similarity criterion; and
responsive to determining that the first image and second image satisfy the second similarity criterion, generating a video sequence based on the first image and second image, wherein the video sequence comprises a plurality of interpolated images corresponding to respective different points in time between a first time associated with the first image and a second time associated with the second image.

31. (canceled)
